(19) United States
(12) Patent Application Publication
(10) Pub. No.: US 2025/0360971 A1
(43) Pub. Date: Nov. 27, 2025

(54) PROPELLER-BASED FLUID REDIRECTION DEVICE USEFUL, FOR EXAMPLE, TO REDUCE DRAG FOR A BLUFF BODY

(71) Applicant: EIDON, LLC, Mercer Island, WA (US)

(72) Inventor: Roger N. JOHNSON, Mercer Island, WA (US)

(73) Assignee: EIDON, LLC, Mercer Island, WA (US)

(21) Appl. No.: 18/873,299

(22) PCT Filed: Jun. 9, 2023
(86) PCT No.: PCT/US2023/068212

§ 371 Date: Dec. 9, 2024

Related U.S. Application Data
(60) Provisional application No. 63/366,224, filed on Jun. 10, 2022.

(51) Int. Cl. B62D 35/00

(52) U.S. Cl. CPC B62D 35/001

(57) ABSTRACT

A system includes a bluff body having a tail end and a wake region and slipstream direction behind the tail end. The system further includes a propeller including a hub and a plurality of blades extending outward from the hub. The hub is mounted to the tail end of the bluff body for rotation about an axis. The axis is angled relative to the slipstream direction in both pitch and yaw such that when fluid is flowing over the bluff body, at least one of the blades is in the slipstream and extracts energy to rotate the hub, while at least one of the blades is out of the slipstream and redirects fluid from the slipstream into the wake region. Such autorotation of the hub causes the blades to continuously move in and out of the slipstream to continuously extract energy and redirect slipstream fluid into the wake region.

### CROSS-REFERENCE TO RELATED APPLICATIONS

The present application claims the benefit of priority to U.S. Provisional Application No. 63/366,224, filed on Jun. 10, 2022, the contents of which are incorporated herein by reference.

### BACKGROUND

Heavy vehicles such as tractor-trailer combinations and buses typically have large forward-facing surfaces and blunt tail surfaces. For these vehicles, pressure drag is the dominant component of aerodynamic drag. For example, as a tractor-trailer moves through air, pressure is increased at its forward-facing surfaces, and a pressure drop occurs at its tail surface. The pressure drag is proportional to the difference between the pressures acting on the forward-facing and tail surfaces. The pressure drag can cause a significant reduction in fuel economy and, consequently, a significant increase in operating costs.

A variety of devices are available for reducing pressure drag. Drag reduction devices such as vortex inducers are installed near the tail end of a vehicle to break up the sheet of passing air into a number of swirling wakes. A drag reduction device such as a tail-end drag reduction device provides a sharp trailing edge that helps the air in the wake swirl in a fashion that slightly reduces the pressure drop. A drag reduction device such as a truncated streamline tail surface helps redirect slipstream air into a wake region downstream of the tail surface.

A disadvantage of these devices is their minimal reduction of tail drag. Some devices are also bulky and relatively heavy.

### SUMMARY

According to one embodiment, a system includes a bluff body having a tail end and a wake region and slipstream direction behind the tail end. The system further includes a propeller including a hub and a plurality of blades extending outward from the hub. The hub is mounted to the tail end of the bluff body for rotation about an axis. The axis is angled relative to the slipstream direction in both pitch and yaw such that when fluid is flowing over the bluff body propeller, at least one of the blades is in the slipstream and extracts energy to rotate the hub, while at least one of the blades is out of the slipstream and redirects fluid from the slipstream into the wake region. Such autorotation of the hub causes the blades to continuously move in and out of the slipstream to continuously extract energy and redirect slipstream fluid into the wake region.

### BRIEF DESCRIPTION OF THE DRAWINGS

Reference will now be made to the attached drawings, when read in combination with the following specification, wherein like reference numerals refer to like parts throughout the several views, and in which:

FIG. 1 is a 2D top view of a system including a bluff body and a propeller for reducing drag in a wake region downstream of the bluff body, while FIG. 2A is a partial 3D view of a portion of the system of FIG. 1, according to one embodiment.

FIG. 2B is an illustration of angle of attack of a blade of the propeller, according to one embodiment.

FIGS. 3 and 4 are illustrations of an example of the propeller, according to one embodiment.

FIG. 5 is an illustration of an example of a propeller mounted to a bluff body, according to one embodiment.

FIG. 6 is an illustration of an example of a mounting structure and a propeller mounted to the structure, according to one embodiment.

FIGS. 7-9 are illustrations of a trailer and a zero-drive propeller-based system for reducing pressure drag at a tail end of the tractor, according to one embodiment.

FIG. 10 is an illustration of a tractor-trailer and a zero-drive propeller-based system for reducing pressure drag in a gap region between the tractor and the trailer, according to one embodiment.

FIG. 11 is an illustration comparing a propeller at the tail end of a tractor-trailer to a propeller in a gap region of the tractor-trailer, according to one embodiment.

FIG. 12 is an illustration of a barge and a zero-drive propeller-based system for reducing pressure drag at a tail end of the barge, according to one embodiment.

FIG. 13 is an illustration of a duct and a zero-drive propeller-based system for redirecting fluid flow and reducing pressure drag inside the duct, according to one embodiment.

FIG. 14 is an illustration of an aerodynamic lift structure, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

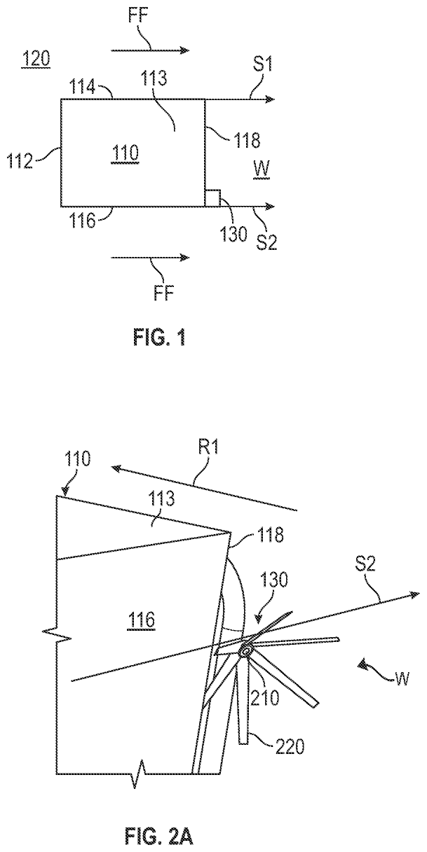

Reference is now made to FIG. 1, which is a top view of a bluff body 110 having a front surface 112, top surface 113, sides 114, 116, lower surface (not shown), and a tail end 118. The bluff body 110 is a body that, as a result of its shape, has separated fluid flow over a substantial part of its surface(s).

The bluff body 110 is surrounded by ambient fluid 120. The ambient fluid 120 may be gas or liquid, for example air or water. Although reference is made to “fluid”, it will be appreciated that fluid broadly refers to any type of gas, liquid, or combination thereof. Arrows FF represent the direction of fluid flow over the bluff body 110. It will be appreciated that the fluid flow may occur over, around, under, and any combination thereof relative the bluff body 110. The fluid flow may result from a relative movement between the bluff body 110 and the ambient fluid 120. The relative movement may result from the bluff body 110 moving through the ambient fluid 120, or by the ambient fluid 120 moving over the bluff body 110, or by movement of both the ambient fluid 120 and the bluff body 110.

A wake region W is located behind the tail end 118 of the bluff body 110. When there is a relative movement between the bluff body 110 and the ambient fluid 120, wakes of fluid form within the wake region W. Pressure in the wake region W is lowered as a result of the relative movement, and pressure drag is increased. Consider the example of a trailer being pulled in a forward direction by a tractor. As the trailer is powered forward, air is pushed aside. Since the tail end 118 of the trailer does not create any air, the surrounding air attempts to flow back in. This is driven by the low pressure there, or the fewer air molecules left in the wake region W. Air attempting to fill the wake region W is drawn from every direction, which causes the tail end 118 of the trailer to be pulled backwards by the air at lower pressure, which in turn is pulling on the air further back. If the trailer, as it moves forward, is constantly removing air from the wake region W, the amount of time to relocate air into the wake region W relates to how much residual low pressure is able to pull back on the tail end 118 of the trailer.

A slipstream refers to fluid moving over the bluff body 110, past the tail end 118, and over the relatively still fluid in the wake region W. For the slipstream formed by the relative movement of ambient air 120 over the side 114, the slipstream flows in the direction of arrow S1. For the slipstream formed by the relative movement of ambient air 120 over the side 116, the slipstream flows in the direction of arrow S2.

The environment created by the bluff body 110 is unlike the environment in which conventional fans and propellers operate. The bluff body 110 creates two distinct zones—the slipstream S1, S2 with fast moving air and the wake region W with little air movement.

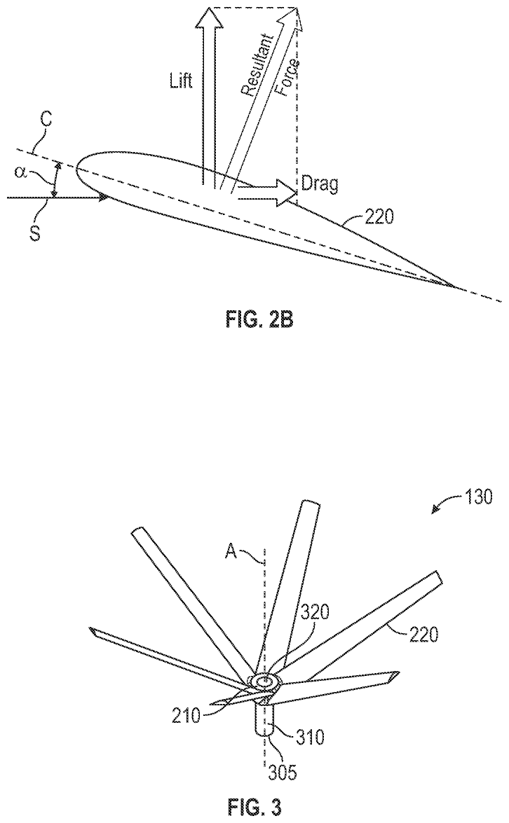

Additional reference is made to FIG. 2A, which illustrates propeller-based air redirection useful for drag reduction for the bluff body 110. A propeller 130 is mounted to the tail end 118 of the bluff body 110. The propeller 130 includes a hub 210 and blades 220 extending outward from the hub 220. The blades 220 have a cross-section that is the shape of an airfoil.

The hub 210 is mounted to the tail end 118 of the bluff body 110 for rotation about an axis. The axis is angled relative to the slipstream direction such that at least one of the blades 220 can enter the slipstream to extract energy to rotate the hub 210, while at least one of the blades 220 is out of the slipstream to redirect fluid from the slipstream into the wake region W.

A blade 220 that extracts energy from the slipstream is in the slipstream at a suitable “angle of attack”. As slipstream fluid flows over the blade 220, lift is created. As the blade 220 traverses the slipstream, it attempts to lift into the fluid flow, but due to the rotational restraint of the hub 210 ends up forcing the blade 220 to rotate. Once the blade 220 transitions out of the slipstream and into the relatively still fluid in the wake region W, it still provides lift, but due to its constrained rotation, pulls the fluid above the blade 220 downwards.

Additional reference is made to FIG. 2B, which illustrates the angle of attack a of the blade 220. The angle of attack a is formed by the chord line C of the blade 220 and the relative direction of the slipstream S. The lift is normal to the fluid slip stream direction S. A suitable angle of attack refers to an angle of attack that creates lift but also provides low drag relative to the extracted energy. The orientation of a blade 220 in the slipstream should not be perpendicular to the slipstream.

A blade 220 that redirects fluid from the slipstream into the wake region W is roughly parallel to the slipstream. Fluid flowing over such a blade 220 is turned from the slipstream into the wake region W in the direction indicated by arrow R1. As the hub 210 rotates, the blades 220 continuously move into and out of the slipstream S1, S2 to continuously extract energy and redirect slipstream fluid into the wake region W.

Fluid flowing over the bluff body 110 and past the tail end 118 is drawn from all directions into the wake region W. However, the propeller 130 increases the flow of the fluid into the wake region W and fills the wake region W faster. The energy captured from the blades 220 in the slipstream drives the other blades 220 (which redirect the fluid) with greater force than the low-pressure region is capable of providing (the low pressure of the wake region W is not controlled in any manner and it has a low force). In this manner, the pressure drop in the wake region W is reduced and pressure drag is reduced.

In a preferred rotation direction of the propeller 130, the blades 220 in the slipstream will produce wash, which is directed downward and inward into the wake region W. This is in addition to the fluid that is redirected by the blades 220 out of the slipstream.

The propeller 130 does introduce some drag. However, that drag is outweighed by the benefits of fluid redirection into the wake region W.

In one embodiment, the propeller-based air redirection and drag reduction is performed without the use of motors or any other external drive devices. That is, the propeller 130 provides pressure drag reduction that is zero-drive. Advantageously, the propeller may be inexpensive, as it may be made of a light flexible, inexpensive material (e.g., plastic).

The use of multiple blades 220, according to one embodiment, provides redundancy. Consider the illustrated example propeller 130 of FIG. 2A, which has six blades 220. Even if a few blades 220 fail, the propeller 130 would still be able to reduce pressure drag so long as at least one blade 220 is extracting power while at least one blade 220 is redirecting fluid into the wake region W.

Although only a single propeller 130 has been described thus far, additional propellers may be mounted to the bluff body 110 (for example, see FIG. 7). For a bluff body 110 having the box-like geometry shown in FIG. 2, all of the propellers 130 may be mounted to a periphery of the tail end, for instance along the upper horizontal edge and/or both vertical edges. The use of multiple propellers 130 provides additional redundancy, where damage to one propeller 130 does not eliminate the array benefit.

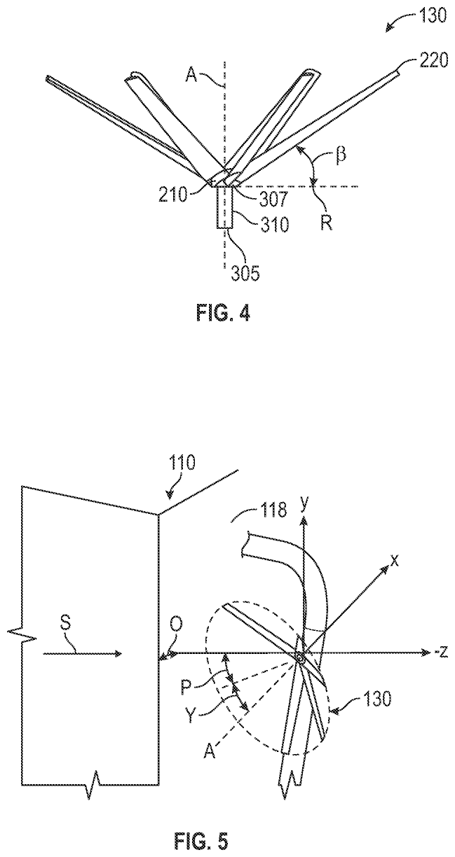

Additional reference is made to FIGS. 3 and 4, which illustrate an example of the propeller 130. In addition to the blades 220 and hub 210, the propeller 130 includes a rigid mounting shaft 310. A first end 305 of the shaft 310 may be mounted to the bluff body 110. The hub 210 is mounted to a second end 307 of the shaft 310 via a bearing 320. Mounted as such, the hub 210 can rotate about an axis of rotation A.

As illustrated in FIGS. 3 and 4, the blades 220 may be angled outward of the hub 210. When the hub 210 is rotated, the blades 220 trace the path of a cone. Let the hub 210 have a plane of rotation R that is perpendicular to the axis of rotation A. The blades 220 may be designed to have a cone angle β between 10 and 45 degrees with respect to the plane R. In one embodiment, the cone angle of 30 degrees has been found to reduce pressure drag significantly. This type of propeller 130 will hereinafter be referred to as a “conical propeller 130.”

Blade length is not limited to any particular range. However, a blade length between 4 to 12 inches can achieve adequate drag reduction for the examples described below, yet the resulting swept diameter is minimal and enables the propeller 130 to be used with a variety of bluff bodies 110.

Longer blades (that is, blades with lengths greater than 12 inches) may be used for greater air redirection. In the alternative, two or more rows of the shorter blades (that is, blades with lengths between 4 and 12 inches) may be used.

The angle of attack a of a blade 220 is non-zero. Because the blade's tip travels much faster than its root, the blade 220 is twisted to make the thrust the same throughout the length of the blade 220. This has the effect of varying the angle of attack a across the entire blade 220. The twist, and other parameters such as width and chord, may be based on propeller size and rotational speed, and velocity of the bluff body 110 through the ambient fluid 120 to generate sufficient lift.

FIG. 5 illustrates the tilt of the propeller 130 and the relation of the blades 220 to the bluff body 110. Let x, y and z represent a coordinate system for the bluff body 110, with the z-axis aligned with the longitudinal axis of the bluff body 110 and the y-axis extending vertically. The tilt may be described by pitch angle P and yaw angle Y with respect to the axis of rotation A of the propeller 130. The pitch angle P refers to the angle of the axis A relative to the oncoming wind and is in the plane perpendicular to the side of the bluff body 110. The pitch angle P is changed by rotating the propeller 130 about the x-axis. The yaw angle Y refers to the angle of the axis A in the plane of the side of the bluff body 110 relative to the slipstream direction S. The yaw angle Y is changed by rotating about the y-axis. Pitching the axis A away from vertical is best if close to the cone angle of the propeller 130. This places one of the blades 220 horizontal. Yawing the blades to the side of the slipstream direction should be less than 90 degrees; otherwise, the incoming wind would oppose rotation on the most forward blades.

FIG. 5 also shows at least one blade 220 in the slipstream and at least one blade 220 out of the slipstream whenever the propeller 130 is being rotated. This allows for both continuous extraction of rotational energy, and continuous redirection of fluid into the wake region W. These actions are accomplished without the use of a motor or other external drive.

Penetration into and time in the slipstream, as used herein, refers to the less than one-half rotation the blades 220 in the slipstream are extracting rotational energy. The axis A of the conical propeller is tilted to ensure that the blades 220 entering the slipstream are properly oriented in a low drag, high lift position, while also ensuring the blades 220 out of the slipstream redirect fluid into the wake region W. This means the blades should not be flat to the incoming slipstream. If this axis is tilted too much the back side of the blade would be impacted by the slipstream and generate drag without lift. Delaying the penetration reduces the time in the slipstream and also changes the entry and exit angles from the slipstream, which can limit drag.

In the illustrated embodiment, the hub 210 is offset by a distance O from the bottom edge of the slipstream, but located within the wake region W. With proper tilt and offset for the conical propeller 130, at least one of those blades 220 out of the slipstream is substantially parallel to the slipstream, at least one of those blades 220 in the slipstream has a non-zero angle of attack that enables the propeller 130 to extract energy from the slipstream. As an example, the offset distance O may be in the range of 0.1 to 0.5 inches.

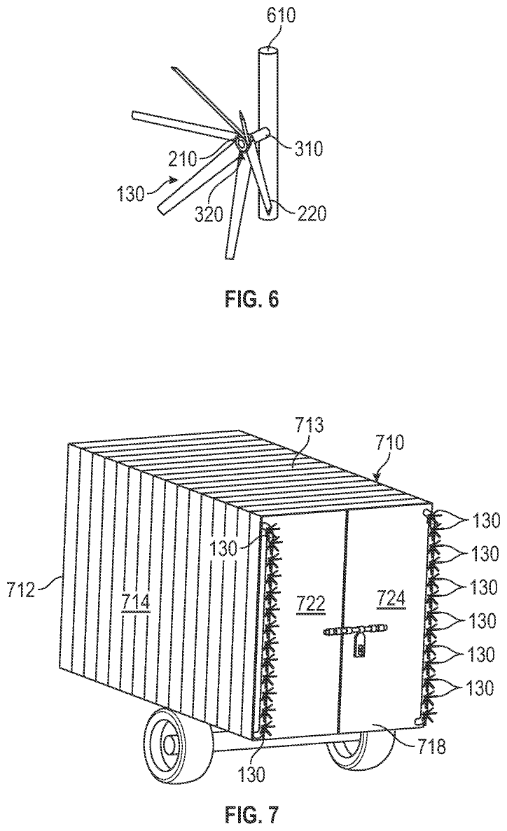

Additional reference is made to FIG. 6, which illustrates an example of a structure for mounting the propeller 130 to the bluff body 110. The structure includes a strut 610, which is attachable to the tail end 118 of the bluff body 110. One end of the mounting shaft 310 of the propeller 130 may be rigidly mounted to the strut 610 at the proper tilt. The bearing 320 enables the hub 210 to rotate about the other end of the mounting shaft 310. The strut 610 creates a separation between the propeller 130 and the tail end 118 to allow unimpeded movement of the blades 220. The strut 610 may have a length that enables more than one propeller 130 to be mounted to it.

It will be appreciated by those of ordinary skill in the art, the propeller-based fluid redirection device for drag reduction is not limited to any particular bluff body 110 or ambient fluid. The following paragraphs provide some examples of different bluff bodies 110 and different ambient fluids 120.

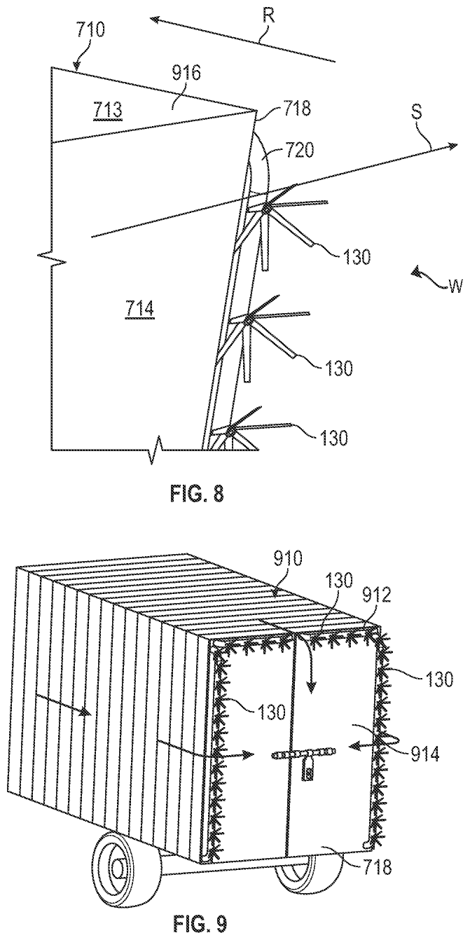

Reference is made to FIGS. 7 and 8. FIG. 7 illustrates a trailer 710 of a tractor-trailer, while FIG. 8 is a blown-up partial view of the tail end 718 of the trailer 710 with multiple propellers 130 mounted to an elongated strut 720, according to one embodiment. The trailer 710 is an example of a box-shaped bluff body. The trailer 710 has a front surface 712, top surface 713, a side 714, an opposite side (hidden from view), a lower surface (also hidden), and a tail end 718. The trailer 710 includes vertical doors 722 and 724 that open outward.

In one embodiment, air is the ambient fluid surrounding the trailer 710. The wake region W is located directly downstream of tail end 718 of the trailer 710. When the trailer 710 is being pulled in a forward direction at a sufficient speed, air pressure increases at the front surface 712, and a slipstream forms in the direction of the arrow S.

Elongated struts 720 are mounted to a perimeter of the tail end 718 of the trailer 710 along opposite vertical edges of the tail end 718. The struts 720 may be affixed to the tail end 718, or they may be removable. Struts 720 secured to the edges via a combination of hooks and straps may be removable.

The mounting shafts 310 of the propellers 130 are affixed to the struts 720. The mounting shafts 310 may be rigid. In the alternative, the mounting shafts 310 may be stiff springs that can be bumped to the side, but are still strong enough to maintain normal orientation during propeller rotation.

The propellers 130 may be mounted to each of the struts 720 in an orientation that allows the blades 220 to continuously move in and out of the slipstream S during motion of the trailer 710 and to continuously extract rotational energy and redirect slipstream fluid into the wake region W. As a result, pressure drag is reduced.

In addition to the advantages mentioned above (i.e., zero-drive, redundancy, low cost, and low drag), the propellers 130 are lighter and less bulky than prior add-on devices. Yet another advantage is that the propellers 130 can be added to the trailer 710 quickly and conveniently. For instance, the propellers 130 may be pre-assembled to the struts 720, and the struts 720 are thereafter mounted to the tail end 718. This is particularly advantageous to truck drivers who do not own their trailers, yet are responsible for paying fuel costs. A truck driver can reduce fuel costs significantly by attaching the struts 720 to the back of the trailers prior to a trip, and remove the struts 720 after the trip.

Yet another advantage of conical propellers 130 made of flexible material and having a minimal swept diameter is they don't interfere with the opening and closing of the doors 722 and 724. If the doors 722 and 724 have hinge spaces, the propellers 130 can fit into the hinge spaces. Even if the doors 722 and 724 do not have hinge spaces, the blades can still collapse into a small enough profile. For instance, the conical shape of the blades 220 could flatten temporarily or the blades 220 could all rotate individually towards a common blade such that, as a group, the blades 220 would fit into a smaller space.

It will be appreciated by those of ordinary skill in the art, the propellers 130 are not limited to the sides of a trailer. Propellers 130 may be mounted to an upper edge instead of or in addition to the sides.

Referring to the embodiment of FIG. 9, a trailer 910 has a row of propellers 130 mounted to an elongated strut extending across the upper edge 912 of the tail end 914. When the trailer 910 is being pulled in a forward direction at a sufficient speed, the blades 220 continuously move in and out of a slipstream (along the upper surface 916) to continuously extract energy and redirect slipstream fluid into the wake region W. There may also be propellers 130 along the sides of the tail end 914.

Propeller-based fluid redirection for drag reduction may not be limited to the tail end 914 of a trailer. Such fluid/air redirection and drag reduction may also be applied to a gap region between the tractor and the front surface of the trailer. The air in this gap region has different characteristics than the air in the wake region W behind the tail end 914 of the trailer. The front of the trailer limits backwards pull, but the air in the gap region is highly turbulent. This turbulent air increases drag.

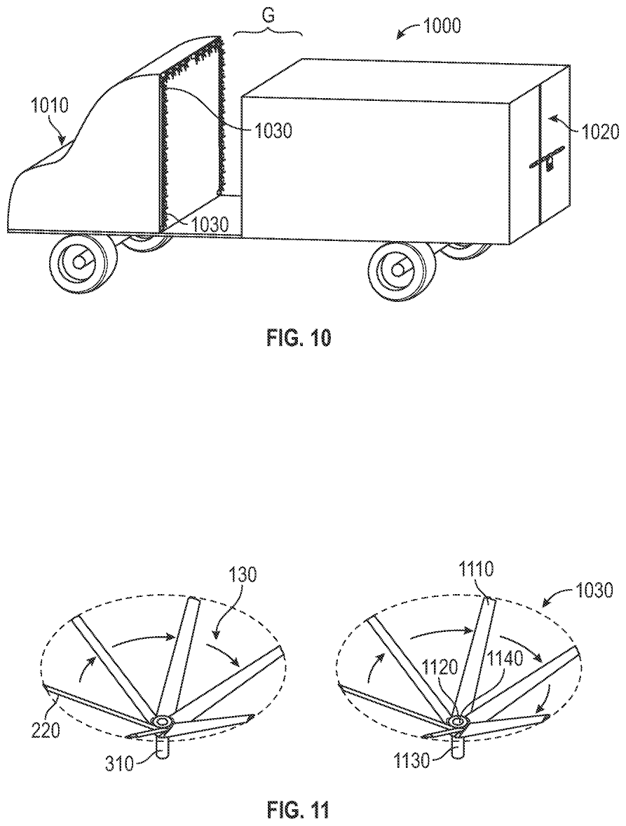

Refence is now made to FIG. 10, which illustrates a tractor-trailer 1000 having a gap region G between the tractor 1010 and the trailer 1020. Propellers 1030 are located in the gap region G and mounted to a perimeter of the trailing surface of the tractor 1010. The propellers 1030 are configured to evacuate air from the gap region G.

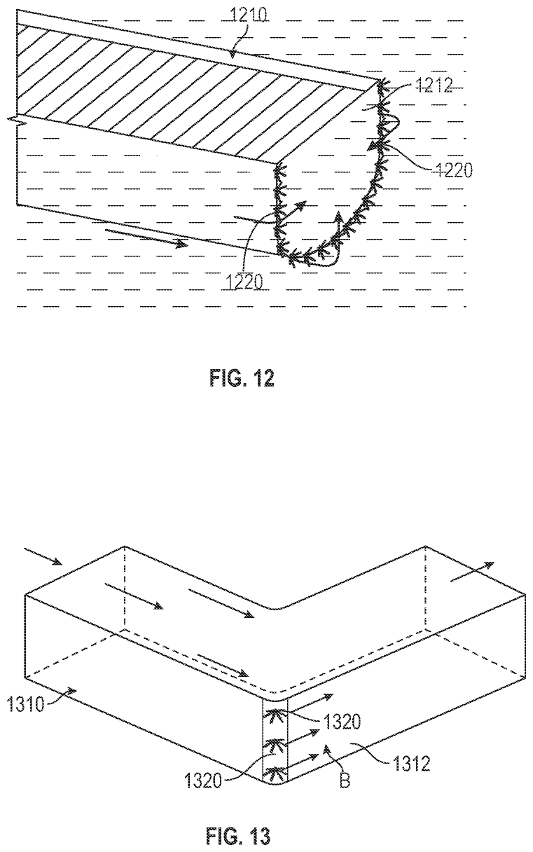

Additional reference is made to FIG. 11, which illustrates a comparison of one of the propellers 130 used at the tail end 914 of a trailer to one of the propellers 1030 in the gap region G between the tractor 1010 and the trailer 1020, according to one embodiment. Both propellers 130 and 1030 rotate in the same direction, and both are conical, but they function differently.

For the propeller 130 at the tail end 914, each blade 220 has an airfoil that is pulled away from the propeller hub 210 when impinged on with moving air. When that blade 220 rotates into the still air in the wake region W, aerodynamic forces tend to lift the blade 220 away from the hub 210. Since the hub 210 is held to the mounting shaft by the bearing, the air is driven in the direction towards the hub 210 and into the wake region W.

For a propeller 1030 in the gap region G, however, each blade 1110 has an airfoil that is mirrored vertically, which preserves the leading edge and the same direction of rotation. The force on the blades 1110 still drives the rotation but with the lift towards the hub 1120. When that blade 1110 rotates into the still fluid it attempts lift towards the hub 1120. Since its hub 1120 is mounted to the shaft 1130 via the bearing 1140, fluid is driven away from the hub 1120. As a result, turbulent air is driven out of the gap region G and into the fast-moving slipstream, and pressure drag is reduced.

Such propeller-based drag reduction in the gap region G has advantages over conventional solutions, such as fairings that bridge part of the gap. Fairings do not always bridge the entire gap due to turning clearance issues. Moreover, fairings are prone to collide with the trailer.

Another embodiment of a tractor-trailer may use propellers 130 at the tail end 914 and propellers 1030 in the gap region G. Propellers 1030 in the gap region G may be secured to the tractor 1010, and propellers 130 at the tail end 914 may be secured to the trailer 910.

Refence is now made to FIG. 12, which illustrates a barge 1210 and a zero-drive propeller-based system for reducing pressure drag at the stern 1212 of the barge 1210. In this example, water is the ambient fluid for the submerged portion of the barge 1210, and air is the ambient fluid above the waterline. Pressure drag is created during movement of the barge 1210. The barge 1210 displaces water to the sides and downward and creates a low-pressure region behind the stern 1212. Water slipstreams form on opposite sides of the low-pressure region.

A plurality of conical propellers 1220 are mounted to the stern 1212 below the barge's waterline. As with the air devices, the extraction of rotational energy from the slipstream is done with blade foils that are in a low drag and lifting profile. The blades out of slipstream redirect water into the low-pressure region to reduce the pressure drag. Water is much denser and can take much higher pressures without stalling. As a result, the blades may be more angled, curved and have a larger cross section.

In some instance, the barge 1210 may move fast enough to create pressure drag due to air being displaced. In those instances, propellers 130 may be mounted to the stern 1212 above the waterline.

Refence is now made to FIG. 13 which illustrates a duct 1310 where propeller-based fluid redirection and drag reduction take place, according to one embodiment. In the embodiment illustrated in FIG. 13, the duct 1310 has a sharp bend 1312 (e.g., 90 degree bend or similar angle). As indicated by the directional arrows, fluid flows into the duct 1310 and changes direction at the bend 1312. Thereafter, the fluid flows out of the duct 1310. Similar to the wake region W behind the bluff body 110, the fluid's directional change can cause a pressure drop at the bend 1312.

In one embodiment, the pressure drop can be reduced by a row of conical propellers 1320 arranged along the inside corner of the bend 1312. Each of the conical propellers 1320 may be positioned such that at least one of the propeller blades will extract energy from the flowing fluid into the duct 1310 in a manner that rotates the blades, while at least one other blade redirects the fluid around the bend 1312. With the low drag incurred by the propellers 1320, they replace the fluid in that low pressure region with less combined drag than without. As a result, a reduction in pressure occurs in the region B after the bend 1312.

Consider four blades of a conical propellor 1320. At a point in the rotation one blade is just entering the fluid stream and is attempting to lift, which creates rotational torque. The next blade is just about to exit the fluid stream and has just provided rotational torque. The next blade has passed out of the fluid stream and is now passing through the relatively still fluid just behind the bend 1312 and, in its attempt to lift, is pulling air from the fluid stream side into the low-pressure region B. The last blade continues this action and drives more fluid into the low-pressure region B. Each blade takes turns performing these functions.

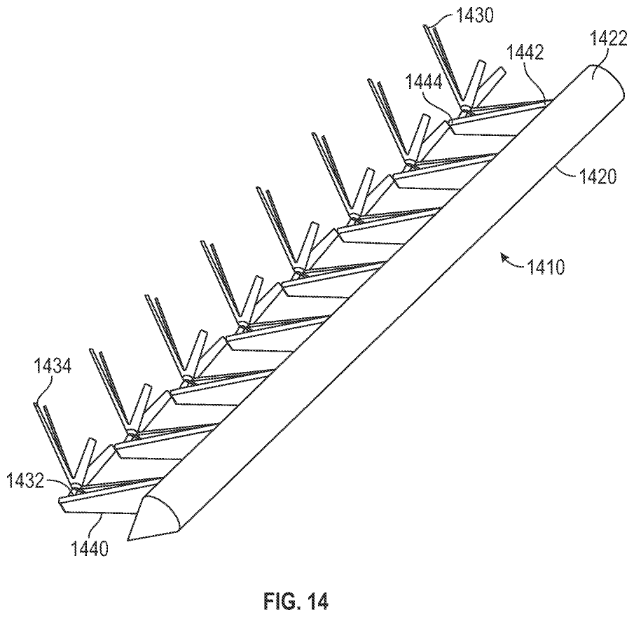

Refence is now made to FIG. 14, which illustrates an aerodynamic lift structure 1410 including a strut 1420 and conical propellers 1430. The strut 1420 has a rounded nose 1422, which forms a leading edge of the structure 1410. A plurality of ribs 1440 are disposed in parallel along the length of the strut 1420. Each rib 1440 has an end 1442 attached to the strut 1420, and each rib 1440 has a free end 1444 downstream of the strut 1420. The ribs 1440 may incorporate the airfoil shape of a wing. Each conical propeller 1430 is mounted at the free end 1444 of a corresponding rib 1440. The propeller 1430 has a mounting shaft 1432 that may be secured to a side of the corresponding rib 1440 and titled such that at least one propeller blade 1434 can extract rotational energy from air flowing past the strut 1420, while at least one other blade 1434 can redirect air. The air is redirected downward to create lift.

In one embodiment, the strut 1410 may be configured as an aircraft wing. In another embodiment, the strut 1410 may be configured as a blade of a wind turbine.

Example 1 may include a system comprising a bluff body having a tail end and a wake region and slipstream direction behind the tail end; and a propeller including a hub and a plurality of blades extending outward from the hub, the hub mounted to the tail end of the bluff body for rotation about an axis, the axis angled relative to the slipstream direction in both pitch and yaw such that when fluid is flowing over the bluff body, at least one of the blades is in the slipstream and extracts energy to rotate the hub, while at least one of the blades is out of the slipstream and redirects fluid from the slipstream into the wake region, whereby autorotation of the hub causes the blades to continuously move in and out of the slipstream to continuously extract energy and redirect slipstream fluid into the wake region.

Alternatively and/or additionally, Example 2 comprises Example 1 further comprising additional ones of the propeller, wherein the bluff body has a box-like geometry, and wherein all of the propellers are mounted to a periphery of the tail end of the bluff body.

Alternatively and/or additionally, Example 3 comprises one or more of Examples 1-2 wherein the propeller includes six blades.

Alternatively and/or additionally, Example 4 comprises one or more of Examples 1-3, wherein the propeller further includes a rigid mounting shaft having first and second ends, the first end mounted to the bluff body, the hub mounted to the second end for rotation about an axis of rotation, the blades angled outward of the hub.

Alternatively and/or additionally, Example 5 comprises one or more of Examples 1-4, wherein the hub has a plane of rotation that is perpendicular to the axis of rotation; and wherein the blades have a cone angle between 10 and 45 degrees with respect to the plane.

Alternatively and/or additionally, Example 6 comprises one or more of Examples 1-5, wherein the cone angle is about 30 degrees.

Alternatively and/or additionally, Example 7 comprises one or more of Examples 1-6, wherein each of the blades has a length of about 4 to 12 inches.

Alternatively and/or additionally, Example 8 comprises one or more of Examples 1-7, wherein the hub is located within the wake region by an offset.

Alternatively and/or additionally, Example 9 comprises one or more of Examples 1-8, wherein the mounting shaft is tilted relative to the bluff body such at least one blade out of the slipstream is substantially parallel to the slipstream and at least one blade in the slipstream is at lift-creating angle of attack.

Alternatively and/or additionally, Example 10 comprises one or more of Examples 1-9, wherein the bluff body includes a trailer, wherein the system includes struts mounted to a perimeter of the trailer's tail end along opposite vertical edges of the tail end, and wherein the propeller and a plurality of additional ones of the propeller are mounted to the struts, whereby the blades continuously move in and out of the slipstream during motion of the trailer to continuously absorb energy and redirect slipstream fluid into the wake region when the trailer is in motion.

Alternatively and/or additionally, Example 11 comprises one or more of Examples 1-10, wherein the propellers are zero-drive.

Example 12 may include a propeller comprising a disc-like hub having a longitudinal axis of rotation; and a plurality of aerodynamically-shaped blades disposed about the hub and extending outward from the hub at a cone angle between 15 and 50 degrees relative to a plane that is perpendicular to the longitudinal axis.

Alternatively and/or additionally, Example 13 comprises Example 12, wherein the cone angle is about 30 degrees.

Alternatively and/or additionally, Example 14 comprises one or more of Examples 12-13, wherein the blades are configured to produce lift towards the hub.

Alternatively and/or additionally, Example 15 comprises one or more of Examples 12-13, wherein the blades are configured to produce lift away from the hub.

Alternatively and/or additionally, Example 16 comprises a strut and a plurality of ones of the propeller of one or more of Examples 12-15 mounted to the strut.

Alternatively and/or additionally, Example 17 comprises a bluff body and the propeller of one or more of Examples 12-16, the bluff body having a tail end and a slipstream region behind the tail end, wherein the propeller further includes a mounting shaft, the hub mounted to a first end of the shaft for rotation about the longitudinal axis, a second end of the shaft mounted to the bluff body at a tilt angle that allows those blades in the slipstream region to extract rotational energy and those blades not in the slipstream region to redirect fluid from the slipstream region.

Alternatively and/or additionally, Example 18 comprises a duct having a bend, and the propeller of one or more of Examples 12-17, the propeller mounted at an inside corner of the bend.

Alternatively and/or additionally, Example 19 comprises a method for the propeller of one or more of Examples 12-18 comprising mounting a shaft of the propeller to a bluff body having a tail end and a wake region and slipstream region behind the tail end such that those blades out of the slipstream region are substantially parallel to the slipstream region.

Example 20 may include a vehicle box-shaped bluff body having a tail end and a slipstream region downstream of the tail end; and a plurality of propellers mounted to the opposite vertical edges of the tail end, each propeller including a hub and a plurality of blades extending outward from the hub at a cone angle of between 10 and 45 degrees, each hub having an axis of rotation angled relative to the tail end and the blades angled relative to the axis such that those blades out of the slipstream region redirect air from the slipstream region.

Alternatively and/or additionally, Example 21 comprises Example 20, wherein the bluff body is part of a trailer.

Alternatively and/or additionally, Example 22 comprises one or more of Examples 20-21, and further comprises a tractor for the trailer, there being a gap region between the tractor and the trailer and slipstream regions outside of the gap region; and a second plurality of propellers mounted to the tractor and located within the gap region, each propeller of the second plurality including a hub and a plurality of blades extending outward from the hub at a cone angle of between 10 and 45 degrees, each hub mounted to the tractor for rotation about an axis that is angled relative to the tractor such that those blades out of the slipstream region redirect air out of the gap region.

Alternatively and/or additionally, Example 23 comprises one or more of Examples 20-22, wherein the bluff body is part of a barge.

The descriptions of the various embodiments herein have been presented for purposes of illustration and are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system comprising:
a bluff body having a tail end and a wake region and slipstream direction behind the tail end; and
a propeller including a hub and a plurality of blades extending outward from the hub, the hub mounted to the tail end of the bluff body for rotation about an axis, the axis angled relative to the slipstream direction in both pitch and yaw such that when fluid is flowing over the bluff body, at least one of the blades is in the slipstream and extracts energy to rotate the hub, while at least one of the blades is out of the slipstream and redirects fluid from the slipstream into the wake region, whereby autorotation of the hub causes the blades to continuously move in and out of the slipstream to continuously extract energy and redirect slipstream fluid into the wake region.

2. The system of claim 1, further comprising additional ones of the propeller, wherein the bluff body has a box-like geometry, and wherein all of the propellers are mounted to a periphery of the tail end of the bluff body.

3. The system of claim 1, wherein the propeller includes six blades.

4. The system of claim 1, wherein the propeller further includes a rigid mounting shaft having first and second ends, the first end mounted to the bluff body, the hub mounted to the second end for rotation about an axis of rotation, the blades angled outward of the hub.

5. The system of claim 4, wherein the hub has a plane of rotation that is perpendicular to the axis of rotation; and wherein the blades have a cone angle between 10 and 45 degrees with respect to the plane.

6. The system of claim 5, wherein the cone angle is about 30 degrees.

7. The system of claim 5, wherein each of the blades has a length of about 4 to 12 inches.

8. The system of claim 5, wherein the hub is located within the wake region by an offset.

9. The system of claim 8, wherein the mounting shaft is tilted relative to the bluff body such at least one blade out of the slipstream is substantially parallel to the slipstream and at least one blade in the slipstream is at lift-creating angle of attack.

10. The system of claim 1, wherein the bluff body includes a trailer, wherein the system includes struts mounted to a perimeter of the trailer's tail end along opposite vertical edges of the tail end, and wherein the propeller and a plurality of additional ones of the propeller are mounted to the struts, whereby the blades continuously move in and out of the slipstream during motion of the trailer to continuously absorb energy and redirect slipstream fluid into the wake region when the trailer is in motion.

11. The system of claim 10, wherein the propellers are zero-drive.

12. A propeller comprising:
a disc-like hub having a longitudinal axis of rotation; and
a plurality of aerodynamically-shaped blades disposed about the hub and extending outward from the hub at a cone angle between 15 and 50 degrees relative to a plane that is perpendicular to the longitudinal axis.

13. The propeller of claim 12, wherein the cone angle is about 30 degrees.

14. The propeller of claim 12, wherein the blades are configured to produce lift towards the hub.

15. The propeller of claim 12, wherein the blades are configured to produce lift away from the hub.

16. A system comprising a strut and a plurality of ones of the propeller of claim 12 mounted to the strut.

17. A system comprising a bluff body and the propeller of claim 12, the bluff body having a tail end and a slipstream region behind the tail end, wherein the propeller further includes a mounting shaft, the hub mounted to a first end of the shaft for rotation about the longitudinal axis, a second end of the shaft mounted to the bluff body at a tilt angle that allows those blades in the slipstream region to extract rotational energy and those blades not in the slipstream region to redirect fluid from the slipstream region.

18. A system comprising a duct having a bend, and the propeller of claim 12, the propeller mounted at an inside corner of the bend.

19. A method for the propeller of claim 12 comprising mounting a shaft of the propeller to a bluff body having a tail end and a wake region and slipstream region behind the tail end such that those blades out of the slipstream region are substantially parallel to the slipstream region.

20. A vehicle comprising:
box-shaped bluff body having a tail end and a slipstream region downstream of the tail end; and
a plurality of propellers mounted to the opposite vertical edges of the tail end, each propeller including a hub and a plurality of blades extending outward from the hub at a cone angle of between 10 and 45 degrees, each hub having an axis of rotation angled relative to the tail end and the blades angled relative to the axis such that those blades out of the slipstream region redirect air from the slipstream region.

21. The vehicle of claim 20, wherein the bluff body is part of a trailer.

22. The vehicle of claim 21, further comprising:
a tractor for the trailer, there being a gap region between the tractor and the trailer and slipstream regions outside of the gap region; and
a second plurality of propellers mounted to the tractor and located within the gap region, each propeller of the second plurality including a hub and a plurality of blades extending outward from the hub at a cone angle of between 10 and 45 degrees, each hub mounted to the tractor for rotation about an axis that is angled relative to the tractor such that those blades out of the slipstream region redirect air out of the gap region.

23. The vehicle of claim 20, wherein the bluff body is part of a barge.
